(19) United States
(12) Patent Application Publication
(10) Pub. No.: US 2004/0203646 A1
(43) Pub. Date: Oct. 14, 2004

(54) System and method for a mobile expert device

(76) Inventors: Michael L. Rudd, Fort Collins, CO (US); Michelle R. Lehmeier, Loveland, CO (US); Jerlyn R. Culp, Fort Collins, CO (US); Brian J. Brown, Fort Collins, CO (US); Kenneth D. Gennetten, Fort Collins, CO (US); Ken R. Stockton, Fort Collins, CO (US); Margaret M.H. Mulligan, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/198,026

(22) Filed: Jul. 18, 2002

(51) Int. Cl. H04M 11/00

(52) U.S. Cl. 455/414.1; 455/403

(57) ABSTRACT

A system and method for providing information to a mobile expert device is disclosed. The method comprises receiving a request for information having a digital component from a user of the mobile expert device regarding a specific topic, routing the request for information to an expert, and transmitting in real-time information relating to the topic to the mobile expert device, the transmitted information based at least in part on the request for information.

### TECHNICAL FIELD OF THE INVENTION

The present invention relates generally to the field of mobile devices, and more particularly to a system and method for a mobile expert device.

### BACKGROUND OF THE INVENTION

Today's consumers expect instantaneous access to information. However, they have to spend considerable time and effort to gather the information they desire. Frequently when they are able to access the information, the information tends to be generic and not personalized to the consumer's specific situation.

### SUMMARY OF THE INVENTION

In accordance with an embodiment of the invention, a method for providing information to a mobile expert device comprises receiving a request for information having a digital component from a user of the mobile expert device regarding a specific topic, routing the request for information to an expert, and transmitting in real-time information relating to the topic to the mobile expert device, the transmitted information based at least in part on the request for information.

In accordance with another embodiment of the invention, a mobile expert device comprises a user input operable to receive a request for information on a topic from a user, a storage medium operable to store at least one digital component associated with the request for information, a display operable to display said at least one digital component, and a communication element operable to transmit the request for information including the at least one digital component to a domain expert and to receive in real-time information from the domain expert.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an elevational view of an embodiment of a mobile expert device according to the teachings of the present invention;

FIG. 2 is a block diagram of an embodiment of a system for providing information in real-time from an expert to the mobile expert device according to the present invention; and

FIG. 3 is a data flow diagram of an embodiment for providing information in real-time from an expert to the mobile expert device according to the present invention.

### DETAILED DESCRIPTION OF THE DRAWINGS

The preferred embodiment of the present invention and its advantages are best understood by referring to FIGS. 1 through 3 of the drawings, like numerals being used for like and corresponding parts of the various drawings.

Currently when a user has a problem relating to a particular subject matter, for example if the user is having problems repairing a faucet, the user has to go to a specialized goods and/or service provider, for example a home improvement center and explain the problem to a customer service representative. Frequently, the service representative is unable to help the user because the service representative is not knowledgeable in the subject matter. The service representative may direct the user to a second service representative who is more knowledgeable in the particular subject matter. The user has to again explain the problem to the second service representative. The second service representative may ask the user specific details about the problem. However, the user, who is typically not an expert in the subject matter, may not have the requested information as the user may not have anticipated a need for the requested information. Thus, the user may have to come back to the service provider with more details at a later time. It should be noted that significant time and energy is spent just to furnish the right information to the right service provider.

The preferred embodiment of the present invention provides the user with the ability to send information, such as a problem, to an expert and receive information from the expert in real-time via a mobile expert device. The submitted problem may relate to the operation of devices or problems related to certain situations, including the operation of the mobile expert device itself. If desired, the information may also relate to other fields in which the user may be interested, for example repair services, education services, sports, and/or the like.

For example, the user may request information regarding a particular topic. The request for information preferably includes a digital component depicting a problem, for example, a picture of the faucet that needs to be repaired. The request for information is routed to an expert. The expert provides information on the requested topic, for example a solution to the problem which is delivered to the user's mobile expert device.

FIG. 1 is an elevational view of an embodiment of a mobile expert device according to the teachings of the present invention. Mobile expert device 100 is preferably a portable device, such as a digital camera. If desired, other devices, such as a portable scanner, a dictaphone, a personal digital assistant (PDA), a multipurpose device, a mobile phone, a laptop, and entertainment devices, such as a personal CD/DVD player, an MP3 player and/or the like, may also be used. Mobile expert device 100 preferably comprises a display 102, at least one button 104, a toggle switch 106 and an antenna 108. If desired, mobile expert device 100 may include a storage medium 110; a listening device 112, such as a speaker; and a speaking device 114, such as a microphone. If desired, mobile expert device 100 may be adapted to couple to an external listening device and an external speaking device. Mobile expert device 100 may also include a conventional global positioning system (not shown).

Display 102 is preferably a Liquid Crystal Display (LCD) and may be used to display text, graphics, images and/or the like. If desired, display 102 may be a touch screen and may be used to control various operations of device 100 and/or to enter information to be stored in device 100.

Toggle switch 106 is preferably used to toggle mobile expert device 100 between different modes, for example, a record mode and a play mode. Thus, mobile expert device 100 may be switched into the record mode to record images, sound, text, data and/or the like. In the play mode mobile expert device 100 is capable of presenting a video file, an image file, an audio file and/or the like.

Button 104 may be used to control one or more operations of device 100, for example, to record audio, video, for example a still image or a movie, and/or the like; to make various selections on display 102; to enter text; and to connect the device to a data storage server via a communication network. Antenna 108 may be used to facilitate connecting device 100 with a communication network.

Storage medium 110 may be a conventional storage medium used for storing information, such as text files, audio files, video files and/or the like. If desired, mobile expert device 100 may be adapted to accept a removable storage medium, for example a floppy disk, a compact disc, a memory stick, a smart media card, a compact flash card, a mini-disk, a micro-drive, and/or the like, now known or later developed.

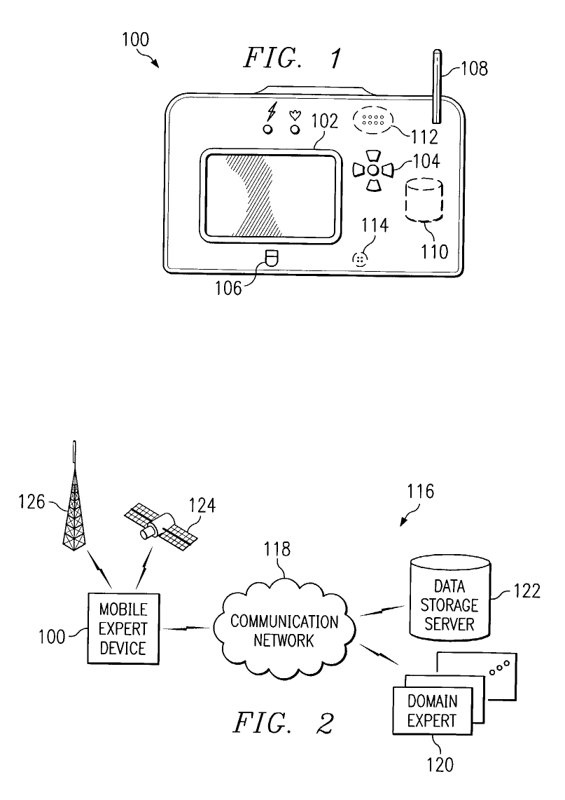

FIG. 2 is a block diagram of an embodiment of a system for providing information in real-time from an expert to the mobile expert device according to the present invention. As shown in FIG. 2, system 116 comprises mobile expert device 100 and at least one data storage server 122. Mobile expert device 100 preferably communicates with data storage server 122 via a communication network 118. Communication network 118 may be a wired network, a wireless network or a combination of both. Communication network 118 preferably comprises a global communication network, such as the Internet.

Mobile expert device 100 is capable of communicating with one or more satellites 124 and one or more transceivers 126, such as one or more cellular towers. The global positioning system may be used to determine the location of mobile expert device 100, for example by a conventional triangulation method. For example, by triangulating signals from three of the satellites and/or communication towers, the location of mobile expert device 100 may be determined.

Preferably data storage server 122 includes a user database and an expert database. The user database preferably includes information about the user, the different types of devices used by the user, the identities associated with each of the devices used by the user, the user's billing information, the user's personal information, such as preferences regarding the type of information the user is interested in receiving, the user's likes, the user's dislikes, medical condition, subscribed services and/or the like.

The expert database includes information about one or more domain experts 120, for example individuals or groups who are knowledgeable in their respective domains. Such information may include, for example, the contact information of the individuals or groups, the fields they are knowledgeable in, their availability, location and/or the like. Although in the preferred embodiment, domain experts are individuals or groups, the invention is not so limited. In alternative embodiments, a domain expert may be a knowledge-based expert system, a software, a database and/or the like.

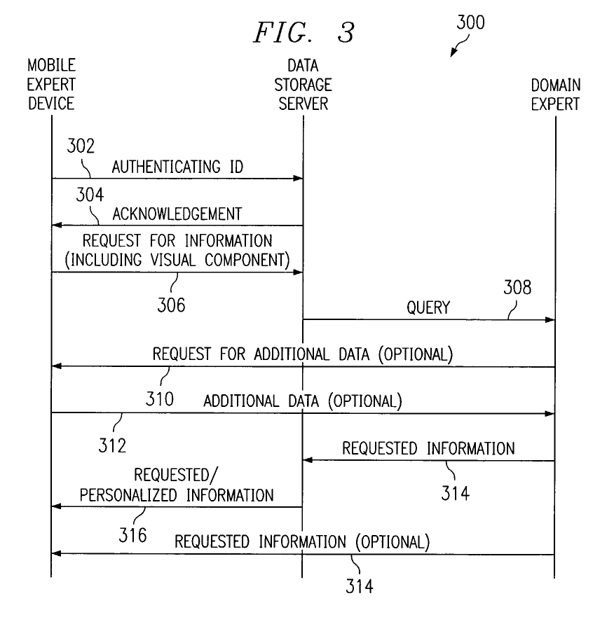

FIG. 3 is a data flow diagram 300 of an embodiment for providing information in real-time from an expert to the mobile expert device. When the user of mobile expert device 100 desires to receive information on a particular topic, the user initiates a session with data storage server 122. In the preferred embodiment, the session is initiated, for example, by mobile expert device 100 transmitting an authenticating ID 302, such as a username and password, to data storage server 122. Preferably, the authenticating ID is transmitted to data storage server 122 via communication network 118. Data storage server 122 verifies the username and password and upon verification transmits an acknowledgment 304 back to mobile expert device 100.

Mobile expert device 100 then transmits a request for information 306 to data storage server 122 via communication network 118. The user may compose the request as described in more detail hereinbelow and transmit the request to data storage server 122 by activating button 104 or any other button on mobile expert device 100. Additionally or alternatively, request for information 306 may be transmitted by selecting different options on display 102.

Request for information 306 preferably relates to a specific topic in which the user is interested. The request could be in the form of a statement of a problem for which the user is seeking a solution. The request for information may be a request for tutorials in various subject areas. Thus, if the user has recently purchased a digital camera, the user may request a tutorial for the camera that would allow the user to learn various features of the camera.

Preferably, request for information 306 includes a digital component, for example digital image(s) stored in storage medium 110. Thus, for example, if the user needs to repair a faucet and desires to consult with an expert on how-to repair the faucet, the user may take one or more pictures of the faucet. A user desiring to receive advice from an expert on how to improve the user's golf swing may have someone take picture(s) or a video of the user's golf swing. The pictures and/or images may be stored on storage medium 110 prior to being transmitted to data storage server 122.

Audio and/or textual information may also be part of the user request for information. Audio information may be recorded, for example by the user speaking into speaking device 114. Textual information may be entered by the user by using button 104 or using display 102 which as mentioned herein may be a touch screen. The audio and/or textual information may include an explanation of the problem or a result the user is trying to obtain. Furthermore, mobile expert device 100 may also transmit its location information to data storage server 122.

Upon receiving request for information 306, in one embodiment, data storage server 122 selects an expert from the expert database to route the request for information to for example someone who is likely to know a solution to the problem. If desired, in one embodiment, the expert may be selected by personnel of the provider of the service. One or more of the following criteria may be used to select an expert: domain of expertise, availability, location of expert, location of user, the user's preferences, user's service level and/or the like. The experts may be classified according to various levels, such as basic, medium, premium and/or the like. Thus, for example, in one embodiment, if the user is subscribed at the basic service level, then an expert may be selected from a group of experts belonging to the basic level, for example a local expert. On the other hand, if the user is subscribed at the premium service level, then an expert may be selected from a group of experts belonging to the premium level, for example experts who are famous or well known in their respective fields. If desired, for a particular request the user may specify a service level different than the user's default service level. Thus, for example, for a particular request a user subscribed at the premium level may specify that an expert classified as a basic expert in the particular field be selected. Preferably, the service level selected determines the cost to the user. It is not necessary that the user be a subscriber for the services.

Upon selection of an expert, data storage server 122 transmits a query 308 to the selected domain expert 120. Query 308 may be identical to request for information 306. If desired, request for information 306 may be modified and routed to selected domain expert 120 as query 308. Domain expert 120 may transmit a request for additional data 310 to mobile expert device 100. Upon receiving request 310, the user of mobile expert device 100 provides additional data 312 to domain expert 120. If desired, a communication channel may be established between domain expert 120 and mobile expert device 100 via communication network 118. The communication channel may allow an interactive session between the user and the expert. Thus, the expert could interview the user regarding the specific problem. Also, if desired, a real-time feed from mobile expert device 100 could be provided to the expert so that the problem could be presented to the expert from various angles. Thus, if the faucet of the user needs to be repaired, a real-time feed of the faucet could be provided to the expert from various angles via the mobile expert device based on instructions from the expert.

Once domain expert 120 has received all the data, it transmits requested information 314, for example a solution to the user's problem, suggestions on how to solve the problem, tutorials and/or the like, to data storage server 122. Requested information 314 is based at least in part on information received from mobile expert device 100. The requested information is based on the initial request for information 306 including any digital components and also any additional data 312 provided by mobile expert device 100 directly to domain expert 120. Thus, the information provided to data storage server 122 is personalized information based on the specific request for information. Furthermore, domain expert 120 may personalize requested information based on location information provided by mobile expert device 100. This may be useful, for example, if the solution to a particular problem depends on the location of the user.

Requested information 314 may include audio information, video information, textual information and/or the like. Data storage server 122 may personalize the information for the particular user based on the user's preferences as stored in the user database. If desired, data storage server 122 may also modify requested information 314 based on mobile expert device 100, for example to fit display 102.

Personalized information 316 is transmitted to mobile expert device 100 by data storage server 122 via communication network 118. If desired, domain expert 120 may provide requested information 314 directly to mobile expert device 100 via communication network 118. Thus, a user is able to receive personalized information provided by an expert on a particular topic in real-time, for example a solution personalized to the user's specific problem.

Although in preferred embodiment of the present invention as described above the user composes request for information 306 after initiating the session with data storage server 122, the invention is not so limited. If desired, request for information 306 may be a request previously stored in mobile expert device 100. The user may store multiple requests in storage medium 110 prior to initiation of the session with data storage server 122. Upon establishing the session with data storage server 122, the user may select a request from the stored requests to be transmitted to server 122.

Also, if desired, mobile expert device 100 could be programmed so that whenever the user activates a specific button on mobile expert device 100, a signal is sent to data storage server 122 identifying the mobile expert device and/or the user to the data storage server. A default request for information, for example the first request stored in mobile expert device 100 may also be transmitted to data storage server 122 along with the identifying information. The advantage of programming mobile expert device 100 in this manner is that the user does not waste air time in composing the request for information after a session has been established. Also, the user does not have to go through the steps of selecting the particular request after a session has been established.

The preferred embodiment of the present invention may be used to provide different kinds of services. For example, in sports it can be used to provide lessons to the user after receiving videos of a user's actions, for example, the user's swing, related to a particular sport, for example, golf, baseball, tennis and/or the like; in repair services, it can be used to provide cost estimates and/or instructions from an expert after receiving images of a project; in the medical field, it can be used to consult with an expert during or concerning a medical procedure. Other applications in which the teachings of the present invention may be used include remote medical procedures, recipe creation, and/or the like.

What is claimed is:

1. A method for providing information to a mobile expert device, comprising:
receiving a request for information having a digital component from a user of the mobile expert device regarding a specific topic;
routing the request for information to an expert; and
transmitting in real-time information relating to the topic to the mobile expert device, the transmitted information based at least in part on the request for information.

2. The method of claim 1, further comprising selecting, based at least in part on the specific topic, an expert to who to route the request for information.

3. The method of claim 1, further comprising selecting, based at least in part on a level of service selected by the user, an expert to who to route the request for information.

4. The method of claim 1, wherein said digital component comprises a digital image.

5. The method of claim 1, further comprising:
receiving the information relating to the topic from the expert; and
transmitting the information to the mobile expert device.

6. The method of claim 5, further comprising personalizing the information received from the expert based at least in part on one or more preferences of the user prior to transmitting the information to the mobile expert device.

7. The method of claim 1, further comprising establishing a communication channel between the mobile expert device and the expert to allow the expert to see in real-time one or more images depicting at least part of a problem relating to the specific topic for which the user is requesting information.

8. The method of claim 1, wherein the information is transmitted from the expert to the mobile expert device via a global communication network.

9. The method of claim 1, wherein the information transmitted to the mobile expert device is based at least in part on a location of the mobile expert device.

10. The method of claim 1, wherein the request for information is transmitted from the mobile expert device.

11. The method of claim 1, wherein the digital component includes at least one image relating to the specific topic for which information is being requested.

12. The method of claim 1, wherein the request for information includes an audio component, wherein the audio component includes a description of a problem relating to the specific topic for which the user is seeking a solution.

13. A mobile expert device, comprising:
a user input operable to receive a request for information on a topic from a user;
a storage medium operable to store at least one digital component associated with the request for information;
a display operable to display said at least one digital component; and
a communication element operable to transmit the request for information including the at least one digital component to a domain expert and to receive in real-time information from the domain expert.

14. The mobile expert device of claim 13, wherein the request for information is a default request stored on the storage medium.

15. The mobile expert device of claim 13, wherein the request for information includes information uniquely identifying the mobile expert device.

16. The mobile expert device of claim 13, wherein the display is a touch screen.

17. The mobile expert device of claim 13, wherein the at least one digital component includes an image relating to the topic for which information is being requested.

18. The mobile expert device of claim 13, wherein the at least one digital component comprises a digital image.

19. The mobile expert device of claim 13, further comprising a global positioning system operable to determine a location of the mobile expert device for transmission to said domain expert.

20. A method for providing information to a user, comprising:
receiving a request for information including an image relating to a problem in a particular subject matter from a mobile expert device of the user;
communicating at least a portion of the request for information including the image to a person knowledgeable in the subject matter;
receiving a solution to the problem from the person; and
providing the solution in real-time to the mobile expert device.

21. The method of claim 20, wherein the solution provided to the mobile expert device is specific to the problem of the user.

22. The method of claim 20, wherein the solution is based at least in part on at least part of the image.

23. The method of claim 20, further comprising selecting the person knowledgeable in the subject matter from a plurality of persons knowledgeable in the subject matter based at least in part on a preference of the user.

24. The method of claim 20, wherein the solution provided to the mobile expert device is based at least in part on a location of the mobile expert device.
